(19) United States
(12) Patent Application Publication
(10) Pub. No.: US 2024/0025209 A1
(43) Pub. Date: Jan. 25, 2024

(54) METALLIC REINFORCING CORD FOR TYRES FOR VEHICLE WHEELS AND TYRE COMPRISING SAID METALLIC REINFORCING CORD

(71) Applicant: Pirelli Tyre S.p.A., Milano (IT)

(72) Inventors: Simone AGRESTI, Milano (IT); Guido Luigi DAGHINI, Milano (IT); Thomas HANEL, Milano (IT)

(73) Assignee: Pirelli Tyre S.p.A., Milano (IT)

(21) Appl. No.: 18/255,488

(22) PCT Filed: Dec. 6, 2021
(86) PCT No.: PCT/IB2021/061369

§ 371 Date: Jun. 1, 2023

(30) Foreign Application Priority Data
Dec. 9, 2020 (IT) 102020000030182

(51) Int. Cl. B60C 9/00; D07B 1/06

(52) U.S. Cl. CPC B60C 9/0007; B60C 9/0057; D07B 1/0646; B60C 2009/2077

(57) ABSTRACT

The invention relates to a metallic reinforcing cord (10) for tyres for vehicle wheels, comprising a single metallic wire (11) extending along a substantially helical path to form a helix having a predetermined pitch (Pw) and, in at least some cross sections thereof, an inner diameter (Di) greater than, or equal to, 0.7 mm.

The present invention relates to a metallic reinforcing cord for tyres for vehicle wheels.

The invention also relates to a tyre for vehicle wheels comprising such a metallic reinforcing cord.

The metallic reinforcing cord of the invention comprises a single metallic wire. Therefore, no other metallic or textile wires are twisted to the aforementioned metallic wire.

### PRIOR ART

Metallic reinforcing cords for tyres for vehicle wheels comprising a single metallic wire are described, for example, in EP 1066989, EP 1162086, EP 1120293, US 2015/0314647 and U.S. Ser. No. 10/391,817.

### SUMMARY OF THE INVENTION

Hereinafter, when reference is made to any range of values comprised between a minimum value and a maximum value, the aforementioned minimum and maximum values are deemed to be included in the aforementioned range, unless expressly stated to the contrary.

Moreover, all of the ranges include any combination of the minimum and maximum values described and include any intermediate range, even if not expressly described specifically.

Any numerical value is deemed to be preceded by the term “about” to also indicate any numerical value that differs slightly from the one described, for example to take into account the dimensional tolerances typical of the field of reference.

Hereinafter, the following definitions apply.

The term “equatorial plane” of the tyre is used to indicate a plane perpendicular to the rotation axis of the tyre and that divides the tyre into two symmetrically equal parts.

The terms “radial” and “axial” and the expressions “radially inner/outer” and “axially inner/outer” are used with reference, respectively, to a direction substantially parallel to the equatorial plane of the tyre and to a direction substantially perpendicular to the equatorial plane of the tyre, i.e. respectively to a direction substantially perpendicular to the rotation axis of the tyre and to a direction substantially parallel to the rotation axis of the tyre.

The terms “circumferential” and “circumferentially” are used with reference to the direction of the annular extension of the tyre, i.e. to the rolling direction of the tyre, which corresponds to a direction lying on a plane coinciding with or substantially parallel to the equatorial plane of the tyre.

The term “substantially axial direction” is used to indicate a direction inclined, with respect to the equatorial plane of the tyre, by an angle comprised between 70° and 90°.

The term “substantially circumferential direction” is used to indicate a direction oriented, with respect to the equatorial plane of the tyre, at an angle comprised between 0° and 10°.

The expressions “upstream” and “downstream” are used with reference to a predetermined direction and to a predetermined reference. Therefore, assuming for example a direction from left to right and a reference taken along said direction, a position “downstream” with respect to the reference indicates a position to the right of said reference and a position “upstream” with respect to the reference indicates a position to the left of said reference.

The term “elastomeric material” is used to indicate a material comprising a vulcanizable natural or synthetic polymer and a reinforcing filler, in which such a material, at room temperature and after having been subjected to vulcanization, can ne subjected to deformations caused by a force and is capable of quickly and energetically recovering the substantially original shape and size after the elimination of the deforming force (according to the definitions of standard ASTM D1566-11 Standard Terminology Relating To Rubber).

The term “metallic reinforcing cord” is used to indicate an elongated element consisting of one or more elongated, thin elements (also called “wires”) made of a metallic material and possibly coated by, or incorporated in, an elastomeric material.

The term “hybrid reinforcing cord” is used to indicate a reinforcing cord comprising at least one metallic wire twisted together with at least one textile yarn. Hereinafter, when reference is made to hybrid reinforcing cords we refer in particular to reinforcing cords comprising textile yarns having low modulus, like for example nylon yarns.

The term “mixed textile reinforcing cord” is used to indicate a reinforcing cord comprising at least one textile yarn having low modulus, like for example a nylon yarn, twisted together with at least one textile yarn having high modulus, like for example an aramid yarn.

The term “yarn” is used to indicate an elongated element consisting of the aggregation of a plurality of textile filaments or fibers.

The yarns can have one or more “ends”, where the term “end” is used to indicate a bundle of filaments twisted together. Preferably, a single end or at least two ends twisted together is/are provided.

The term “diameter” of a reinforcing cord, or of a wire, is used to indicate the diameter measured as prescribed by method BISFA E10 (The International Bureau For The Standardization Of Man-Made Fibres, Internationally Agreed Methods For Testing Steel Tyre Cords, 1995 edition).

In the case of yarns, the term “diameter” is used to indicate the diameter of an ideal circumference that circumscribes all of the filaments that define the yarn. The diameter of a yarn increases as the number of filaments and/or ends of which it consists increases.

The term “thread count” of a layer is used to indicate the number of reinforcing cords per unit length present in such a layer. The thread count can be measured in cords/dm (number of cords per decimeter).

The term “linear density” or “count” of a cord or of a yarn is used to indicate the weight of the cord or of the yarn per unit length. Linear density can be measured in dtex (grammes per 10 km length).

The term “modulus” of a cord or textile yarn is used to indicate the ratio between tenacity (load or force normalized to the linear density) and elongation measured at any point of a tenacity-elongation curve according to the BISFA standard. Such a curve is traced by calculating the first derivative of the tenacity-elongation function that defines the aforementioned curve, where the linear density is expressed in Tex. The modulus is therefore expressed in cN/Tex. In a tenacity-elongation graph, the modulus is identified by the slope of the aforementioned curve with respect to the X-axis.

The term “initial modulus” is used to indicate the modulus calculated at the origin point of the tenacity-elongation curve, i.e. for an elongation equal to zero.

The term “high modulus” is used to indicate an initial modulus equal to or greater than 3000 cN/Tex. The term “low modulus” is used to indicate an initial modulus lower than 3000 cN/Tex.

For the measurement of the linear density and of the modulus reference is made to flat wires/yarns, without twists applied in the testing step or in the twisting step, according to the tests regulated by BISFA.

The terms “breaking load” and “elongation at break” of a reinforcing cord are used to indicate, respectively, the load and the percentage elongation at which the reinforcing cord breaks, evaluated with method BISFA E6 (The International Bureau For The Standardization Of Man-Made Fibres, Internationally Agreed Methods For Testing Steel Tyre Cords, 1995 edition).

The term “part load elongation” of a reinforcing cord is used to indicate the difference between the percentage elongation obtained by subjecting the reinforcing cord to a traction of 50 N and the percentage elongation obtained by subjecting the reinforcing cord to a traction of 2.5 N. The part load elongation is evaluated with method BISFA E7 (The International Bureau For The Standardization Of Man-Made Fibres, Internationally Agreed Methods For Testing Steel Tyre Cords, 1995 edition).

The term “rigidity” of a reinforcing cord is used to indicate the resistant moment to bending with predetermined angle (normally 15°) evaluated with method BISFA E8 (The International Bureau For The Standardization Of Man-Made Fibres, Internationally Agreed Methods For Testing Steel Tyre Cords, 1995 edition).

The term NT steel wire “Normal Tensile Steel” is used to indicate a carbon steel wire having a breaking tensile strength of 2800±200 MPa, for example having a breaking tensile strength of at least 2700 MPa for a wire diameter of 0.28 mm.

The term “HT steel wire” (High Tensile Steel) is used to indicate a carbon steel wire having a breaking tensile strength of 3200±200 MPa, for example a breaking tensile strength of at least 3100 MPa for a wire diameter of 0.28 mm.

The term “ST steel wire” (Super Tensile Steel) is used to indicate a carbon steel wire having a breaking tensile strength of 3500±200 MPa, for example a breaking tensile strength of at least 3400 MPa for a wire diameter of 0.28 mm.

The term “UT steel wire” (Ultra Tensile Steel) is used to indicate a carbon steel wire having a breaking tensile strength of 3900±200 MPa, for example a breaking tensile strength of at least 3800 MPa for a wire diameter of 0.28 mm.

The tolerances ±200 MPa are indicated to comprise, for each class of steel, the minimum and maximum breaking strength values due to the various wire diameters (the breaking strength value is typically inversely proportional to the diameter of the wire), for example for wire diameters comprised between 0.12 mm and 0.40 mm.

The term “mechanical behavior” of a reinforcing cord is used to indicate the reaction offered by the reinforcing cord when subjected to a load (or force). In the case of traction load, such a load results in an elongation that is variable depending on the size of the load according to a function identified by a particular load-elongation curve. The mechanical behavior depends on the material of the wire(s) and/or yarn(s) used, on the number of such wires/yarns, on their diameter or count and on the possible twisting pitch.

The term “winding pitch” of a helix is used to indicate the distance between two consecutive points of the helix in a longitudinal section thereof.

The term “inner diameter” of a helix is used to indicate the diameter of the volume (or empty space) that extends, along a longitudinal axis coinciding with that of the helix, inside the points of the helix closest to the aforementioned longitudinal axis (hereinafter indicated with: inner points), such a diameter being obtained by measuring, in a first cross section plane of the helix, the distance between the inner point of a first coil of the helix intersected by the aforementioned first plane and the point of projection on such a first plane of the inner point of a second coil of the helix intersected by a second cross section plane of the helix arranged at a distance from the aforementioned first plane that is equal to the winding pitch of the helix. The term “high-performance tyres” is used to indicate tyres typically intended to be used in high and ultra-high performance automobile wheels. Such tyres are commonly defined as “HP” or “UHP” and allow to reach speeds of over 200 km/h, up to more than 300 km/h. Examples of such tyres are those belonging to classes “T”, “U”, “H”, “V”, “Z”, “W”, “Y”, according to the E.T.R.T.O. (European Tyre and Rim Technical Organization) standard and racing tyres, in particular for high-piston displacement four-wheeled vehicles. Typically, tyres belonging to such classes have section width equal to or greater than 185 mm, preferably comprised between 195 mm and 385 mm, more preferably comprised between 195 mm and 355 mm. Such tyres are preferably mounted on rims having fitting diameters equal to or greater than 13 inches, preferably not greater than 24 inches, more preferably comprises between 16 inches and 23 inches. Such tyres can also be used in vehicles different from the aforementioned automobiles, for example in high-performance sports motorcycles, i.e. motorcycles capable of reaching speeds even greater than 270 km/h. Such motorcycles are those that belong to the category typically identified with the following classifications: hypersport, supersport, sport touring, and for lower speed indices: scooter, trail bike and custom.

The term “tyre for motorcycle wheels” is used to indicate a tyre having a high ratio of curvature (typically greater than 0.200), capable of reaching high camber angles during cornering of the motorcycle.

Hereinafter, when reference is made to automobile tyres this is deemed to include both tyres for cars, like for example the high-performance tyres defined above, and tyres for light transportation vehicles, for example trucks, vans, campervans, pick-up trucks, typically with total mass at full load equal to or less than 3500 Kg. Therefore, tyres for heavy load vehicles are excluded.

The term “radial carcass structure” is used to indicate a carcass structure comprising a plurality of reinforcing cords each of which is oriented along a substantially axial direction. Such reinforcing cords can be incorporated in a single carcass layer or in a plurality of carcass layers (preferably two) radially juxtaposed over one another.

The term “crossed belt structure” is used to indicate a belt structure comprising a first belt layer including reinforcing cords substantially parallel to one another and inclined with respect to the equatorial plane of the tyre by a predetermined angle and at least one second belt layer arranged in a radially outer position with respect to the first belt layer and including reinforcing cords substantially parallel to one another and oriented with opposite inclination to the cords of the first layer with respect to the equatorial plane of the tyre.

The term “zero degrees belt layer” is used to indicate a reinforcing layer comprising at least one reinforcing cord wound on the belt structure according to a substantially circumferential winding direction.

The term “structural component” of a tyre is used to indicate any layer of elastomeric material of the tyre including reinforcing cords.

In order to keep down the emissions of CO2 into the atmosphere, the Applicant has for many years been producing tyres for automobile and motorcycle wheels having a low rolling resistance. Such tyres comprise, in the crossed belt structures and/or in the reinforcing structures of the bead indicated below with “chafer”, metallic reinforcing cords comprising a plurality of particularly light steel wires, for example having a diameter equal to 0.22 mm, 0.20 mm or 0.175 mm, twisted together.

The choice of the Applicant to use reinforcing cords comprising only steel wires in the aforementioned structural components of the tyre derives from the fact that the steel wires, having high rigidity and excellent resistance to fatigue, are capable of providing the reinforcing cord, and therefore the aforementioned structural components of the tyre, with a high resistance to the high compression or bending stresses to which such structural components are typically subjected during travel of the vehicle on which the tyre is mounted. Moreover, thanks to the high heat conduction capability of the steel, steel wires have high thermostability, providing the reinforcing cord with a stable mechanical behavior even in extreme usage conditions, such as those typical of high-performance tyres.

The Applicant has also observed that the steel ensures good adhesion of the reinforcing cord to the elastomeric material that surrounds it, with consequent advantages in terms of structural integrity and quality of the tyre.

The Applicant has however observed that in order to avoid risks of corrosion of the steel in the case of water infiltration inside the tyre and, at the same time, maximize the adhesion between steel and elastomeric material, it is advisable to ensure that, at each cross section of the reinforcing cord and, therefore, along the entire longitudinal extension of the reinforcing cord, the elastomeric material surrounds as completely as possible each steel wire. Therefore, it is desirable for the elastomeric material to completely surround each steel wire. This also in order to limit as much as possible the number of areas of possible mutual contact of the steel wires, which would actually constitute areas of possible formation of fretting cracks, at the expense of the structural integrity of the tyre.

According to the Applicant, a complete and homogeneous arrangement of the elastomeric material around each steel wire should also imply a more homogeneous hysteresis behavior of the structural component of the tyre, with consequent reduction of the risks of formation of cracks at the transition areas between steel wires and elastomeric material.

The Applicant believes that, in the absence of particular provisions, in the aforementioned metallic reinforcing cords the presence of a plurality of steel wires twisted together could prevent achieving a complete and homogeneous arrangement of the elastomeric material around the steel wires.

The Applicant has also observed that the steel wires, having a low part load elongation, are not suitable for being used in the structural components of the tyre where it is desired to have a significant part load elongation, like for example in the zero degrees belt layers of tyres for automobiles and motorcycles. In such structural components it is preferable to use textile reinforcing cords, like for example reinforcing cords made of nylon or, in cases in which high rigidity at high loads (and therefore high modulus at high loads) is also required, mixed or hybrid textile reinforcing cords.

With particular reference to mixed and hybrid textile reinforcing cords, they make it possible to achieve the desired part load elongation and the desired rigidity thanks to their typical “double modulus” mechanical behavior obtained by means of the use of a material having a low modulus and of a material having a high modulus. At low loads, the mechanical behavior of the reinforcing cord is mainly dictated by the reaction offered by the material having low modulus, whereas at high loads the mechanical behavior of the reinforcing cord is mainly dictated by the reaction offered by the material having high modulus. Such types of reinforcing cords therefore have a mechanical behavior that provides, in a load-elongation graph, a curve defined by two segments separated by a connecting knee, in which the segment to the left of the knee (indicative of the elongations at low loads) has an inclination with respect to the X-axis that is much lower than that of the segment to the right of the knee (indicative of the rigidity).

The Applicant has however observed that mixed and hybrid textile reinforcing cords, unlike metallic ones, do not allow adequate adhesion of the surrounding elastomeric material.

The Applicant has therefore thought that it would be desirable to be able to use metallic reinforcing cords also in all of the structural components of the tyre where currently, in order to be able to obtain high part load elongation, mixed or hybrid textile reinforcing cords are used. Indeed, in this case it would be possible to obtain the desired adhesion between reinforcing cord and surrounding elastomeric material also in the aforementioned structural components without the need to apply an adhesive coating to the reinforcing cord or subject it to adhesion treatments. Moreover, it is desirable to maximize the adhesion of the elastomeric material to the reinforcing cord.

The Applicant has perceived that it is possible to achieve these goals by making metallic reinforcing cords comprising a single metallic wire shaped like a helix.

The Applicant has indeed considered that the helix shape of the aforementioned metallic wire, in addition to maximizing the adhesion of the elastomeric material to the metallic wire and impeding the metallic wire from protruding out of the structural component of the tyre (since the mechanical adhesion of the elastomeric material is better on a helical wire with respect to a wire that is substantially straight or wavy on a single plane), provides the metallic reinforcing cord with a “double modulus” mechanical behavior similar to that typical of mixed or hybrid textile reinforcing cords. In particular, at low loads, a stretching of the helix defined by the metallic wire is obtained (the reinforcing cord in this case behaves like a spring), thereby achieving the desired part load elongation, whereas at high loads the metallic wire reacts due to the high elastic modulus typical of the metallic material, thereby achieving the desired high rigidity at high loads.

Moreover, the Applicant is convinced that the helical geometry, by providing the reinforcing cords with the capability of extending longitudinally when subjected to a load, allows the metallic reinforcing cords used in the crossed belt structures to keep their design angle of inclination during the tyre shaping process.

The Applicant has also perceived that in order to optimize the mechanical behavior at low loads and maximize the adhesion of the elastomeric material to the metallic wire, it is advisable for the helix defined by the metallic wire to have, in at least some cross sections thereof, a sufficiently large inner diameter, in particular greater than 0.7 mm.

According to the Applicant, in this way a more even distribution of the metallic material in the structural component and, consequently, a more homogeneous and even response of such a structural component to the various stresses to which the tyre is subjected during travel would be obtained, with consequent benefits in terms of rigidity, driving stability and responsiveness.

The present invention therefore relates, in a first aspect thereof, to a metallic reinforcing cord for tyres for vehicle wheels.

Preferably, the metallic reinforcing cord comprises a single metallic wire.

Preferably, said single metallic wire extends along a substantially helical path to form a helix.

Preferably, said helix has a predetermined winding pitch.

Preferably, in at least some cross sections thereof, said helix has an inner diameter greater than, or equal to, 0.7 mm.

In a second aspect thereof, the present invention relates to a tyre for vehicle wheels.

Preferably, the tyre comprises at least one reinforcing layer.

Preferably, said at least one reinforcing layer is delimited by two opposite interface surfaces.

Preferably, said at least one reinforcing layer includes a plurality of metallic reinforcing cords.

Preferably, said plurality of metallic reinforcing cords is arranged between said two opposite interface surfaces.

Preferably, at least some of said metallic reinforcing cords are metallic reinforcing cords according to the first aspect of the invention.

The Applicant believes that a reinforcing cord in accordance with the present invention, in addition to making it possible to satisfy all of the requirements discussed above, also makes it possible to eliminate, or at least limit, the undesired effects caused by the shearing forces typically present inside the structural components of the tyres in which metallic reinforcing cords are used.

The Applicant has indeed observed that in tyres in which conventional metallic reinforcing cords are used, the metallic wires are positioned only at a central portion of the thickness of the structural component, such a central portion being arranged between two opposite layers made of only elastomeric material. Such positioning results, during use of the tyre, in the occurrence of undesired shearing forces at the areas that delimit the aforementioned central portion with respect to each of the aforementioned opposite layers made of only elastomeric material. Such shearing forces cause internal lacerations that jeopardize the structural integrity of the structural component, and therefore the performance of the tyre.

The Applicant is convinced that, in tyres in which the metallic reinforcing cords of the present invention are used, thanks to the high inner diameter of the helix defined by the metallic wire, the metallic reinforcing cords occupy an area of the structural component having a size greater than that occupied by single-wire metallic reinforcing cords currently known, thus attenuating the formation of the aforementioned shearing forces and, consequently, increasing the rigidity of the tyre with respect to such shearing forces.

The Applicant also believes that due to the helical shape and the high inner diameter of the helix defined by the metallic wire, the metallic reinforcing cords of the invention can have elongations at low loads (and elongations at break) much greater than those of conventional metallic reinforcing cords of similar construction. This makes it possible to use the metallic reinforcing cords of the invention also in the structural components of the tyre (like for example the zero degrees belt layers of tyres for automobiles and motorcycles) where currently, in order to be able to obtain a high part load elongation, textile reinforcing cords having low modulus are used, like for example reinforcing cords made of nylon or, where high rigidity at high loads (and therefore high modulus at high loads) is also required, mixed or hybrid textile reinforcing cords.

Depending on the particular intended application it is possible to choose the specific geometry of the metallic reinforcing cord of the invention which is deemed most suitable, by suitably selecting the inner diameter and/or the winding pitch of the helix and/or the diameter of the metallic wire.

For example, by increasing the inner diameter of the helix and/or the winding pitch thereof and/or the diameter of the metallic wire it is possible to increase the amount of elastomeric material incorporated in a piece of structural component having a predetermined thickness and distribute the metallic wire more evenly in such a piece of structural component, thus achieving an increase in rigidity of such a structural component and a better transmission of the stresses borne by such a structural component during use of the tyre, to the benefit of responsiveness. On the other hand, by increasing the inner diameter of the helix and reducing the winding pitch thereof it is possible to increase the part load elongation and the elongation at break.

Moreover, depending on the particular geometry which is chosen, the metallic reinforcing cord of the invention can be more suitable for being used in some structural components of the tyre with respect to other structural components of the tyre. For example, it is possible to foresee a geometry adapted for maximizing the rigidity and/or the breaking load, or a different geometry adapted for maximizing the part load elongation and/or the elongation at break.

According to the Applicant, it is preferable to maximize the rigidity and/or the breaking load when the metallic reinforcing cord is intended to be used in the crossed belt structures of tyres for automobile wheels, or in the reinforcing structures of the bead, indicated below with “chafer”, of tyres for wheels of automobiles or motorcycles, or in the carcass structures of tyres for motorcycle wheels, whereas it is preferable to maximize the part load elongation and/or the elongation at break when the metallic reinforcing cord is intended to be used in the zero degrees belt layers of tyres for wheels of automobiles and motorcycles.

The Applicant believes that, for example:
in order to maximize the rigidity and/or the breaking load it is possible to increase the diameter of the metallic wire, keeping other parameters the same;
in order to maximize the part load elongation and/or the elongation at break it is possible to reduce the winding pitch of the helix.

For example, with a winding pitch comprised between 2 mm and 10 mm and an inner diameter comprised between 1 mm and 5 mm it is possible to achieve very high values of part load elongation and of elongation at break, for example even greater than 2.5% and 5%, respectively, whereas, keeping the inner diameter the same, with winding pitches comprised between 10 mm and 35 mm much lower values of part load elongation and of elongation at break are obtained, for example equal to 1.5% and 4% respectively, which are the maximum values that can be obtained with the conventional deformation processes of known metallic wires, like preforming or pleating, that provide for the passage of the metallic wire on a plurality of cylinders of low diameter (for example comprised between 1 and 5 mm) with a predetermined pull.

An advantageous effect linked to the possibility of increasing the winding pitch of the metallic wire is that of increasing the amount of metallic reinforcing cord produced in a given time, with consequent economic and production advantages.

The present invention can, in both of the aspects discussed above, have at least one of the preferred features described hereinafter. Such features can therefore be present singularly or in combination with each other, unless expressly stated to the contrary.

Preferably, the metallic wire is made of steel.

Preferably, the inner diameter of the helix is greater than, or equal to, twice the diameter of the metallic wire, possibly greater than, or equal to, three times the diameter of the metallic wire.

It is possible to make metallic reinforcing cords with different size of the inner diameter of the helix at different cross sections of the metallic reinforcing cord.

Preferably, said metallic reinforcing cord consists of said single metallic wire.

Preferably, the inner diameter of the helix is lower than, or equal to, 4 mm, more preferably lower than, or equal to, 3.5 mm, even more preferably lower than, or equal to, 3 mm

Preferably, the inner diameter of the helix is greater than 0.8 mm, more preferably greater than, or equal to, 0.9 mm.

In preferred embodiments, the inner diameter of the helix is comprised between 0.7 mm and 4 mm, preferably between 0.8 mm and 3.5 mm, more preferably between 0.9 mm and 3 mm.

Preferably, said inner diameter remains substantially constant in at least some cross sections of the helix, except for minimal variations not greater than 5% in absolute value.

The metallic wire is therefore in the form of a substantially regular and uniform helix, i.e. with a substantially constant inner diameter for at least part of the longitudinal extension thereof.

Preferably, the helical shape of the metallic wire is obtained by twisting the metallic wire together with a textile yarn that is subsequently removed. After the removal of the textile yarn the metallic wire does not have permanent deformations and residual tensions, which on the other hand are present in the metallic wires obtained through the preforming or pleating processes discussed above. Such processes typically produce metallic wires having a non-regular wavy shape.

Preferably, the metallic wire has a diameter lower than, or equal to, 0.35 mm, more preferably lower than, or equal to, 0.3 mm.

Preferably, the metallic wire has a diameter greater than, or equal to, 0.08 mm, more preferably greater than, or equal to, 0.1 mm.

In preferred embodiments, the diameter of the wire is comprised between 0.08 and 0.35 mm, preferably between 0.1 mm and 0.3 mm.

Preferably, the winding pitch of the helix is greater than, or equal to, 2 mm, more preferably greater than, or equal to, 5 mm, even more preferably greater than, or equal to, 10 mm.

Preferably, the winding pitch of the helix is lower than, or equal to, 35 mm.

In preferred embodiments, the winding pitch of the helix is comprised between 2 mm and 35 mm, preferably between 5 mm and 35 mm, even more preferably between 10 mm and 35 mm.

Preferably, in at least some cross sections of said at least one reinforcing layer, the metallic wire is separated from one of said opposite interface surfaces by a distance lower than or equal to the diameter of the metallic wire.

It is preferred to still leave a layer of only elastomeric material on opposite sides with respect to the metallic wire so as to also avoid any minimal risk for the metallic wire to protrude out of the aforementioned opposite interface surfaces.

### DESCRIPTION OF THE FIGURES

Further features and advantages of the present invention will become clearer from the following detailed description of a preferred embodiment thereof, made with reference to the attached drawings.

In such drawings:

FIG. 1 is a schematic partial half-cross section view of a portion of an embodiment of a tyre in which a metallic reinforcing cord in accordance with the present invention can be used;

FIG. 2 is a photo of a segment of an embodiment of a metallic reinforcing cord in accordance with the present invention;

FIG. 3 is a photo of a textile yarn used to make the metallic reinforcing cord of FIG. 2;

FIG. 3a is a photo of an elongated element used to make a metallic reinforcing cord in accordance with the present invention, such an elongated element comprising the textile yarn of FIG. 3;

FIG. 4 is a schematic view of a first embodiment of an apparatus for making the metallic reinforcing cord in accordance with the present invention, such an apparatus carrying out a continuous process;

FIGS. 5a and 5b illustrate a second embodiment of an apparatus for making the metallic reinforcing cord in accordance with the present invention, such an apparatus carrying out a discontinuous process;

FIG. 6 shows an example of conventional metallic reinforcing cord and various examples of metallic reinforcing cords made in accordance with the present invention; some cross sections of each of the aforementioned reinforcing cords in a respective structural component of the tyre are also illustrated.

### DETAILED DESCRIPTION OF EMBODIMENTS OF THE INVENTION

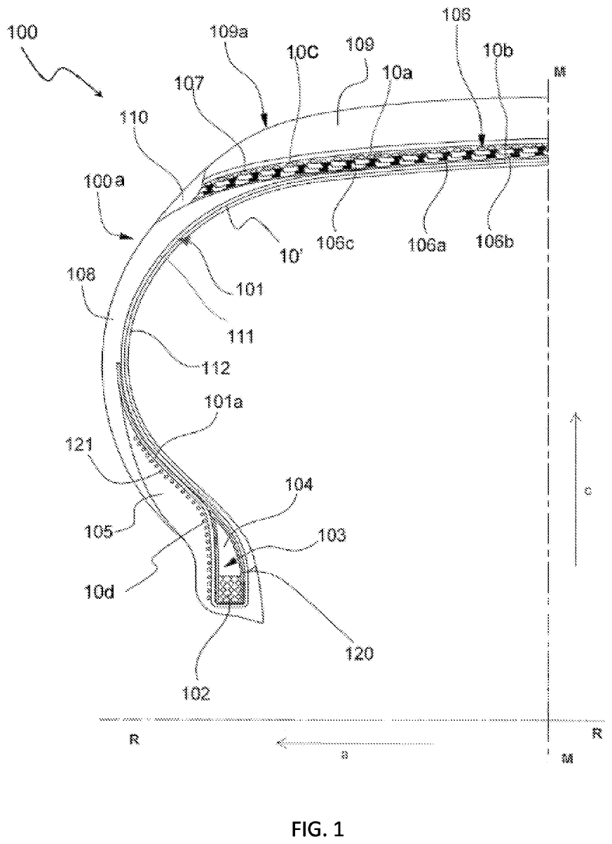

For the sake of simplicity, FIG. 1 shows only one side of an embodiment of a tyre 100 for vehicle wheels, the remaining side, which is not represented, being substantially identical and being arranged symmetrically with respect to the equatorial plane M-M of the tyre.

The tyre 100 illustrated in FIG. 1 is, in particular, a tyre for four-wheeled vehicles.

More in particular, the tyre 100 is an HP or UHP tyre for sports and/or high or ultra-high performance vehicles.

In FIG. 1 “a” indicates an axial direction, “c” indicates a radial direction, “M-M” indicates the equatorial plane of the tyre 100 and “R-R” indicates the rotation axis of the tyre 100.

The tyre 100 comprises at least one support structure 100a and, in a radially outer position with respect to the support structure 100a, a tread band 109 made of elastomeric material.

The support structure 100a comprises a carcass structure 101, which in turn comprises at least one carcass layer 111.

Hereinafter, for the sake of simplicity of presentation, reference will be made to an embodiment of the tyre 100 comprising a single carcass layer 111, nevertheless being understood that what is described has analogous application in tyres comprising more than one carcass layer.

The carcass layer 111 has axially opposite end edges engaged with respective annular anchoring structures 102, called bead cores, possibly associated with an elastomeric filler 104. The area of the tyre 100 comprising the bead core 102 and the possible elastomeric filler 104 forms an annular reinforcing structure 103 called “bead structure” and intended to allow the tyre 100 to be anchored on a corresponding mounting rim, not illustrated.

The carcass layer 111 comprises a plurality of reinforcing cords 10′ coated with elastomeric material or incorporated in a matrix of cross-linked elastomeric material.

The carcass structure 101 is of the radial type, i.e. the reinforcing cords 10′ are located on planes comprising the rotation axis R-R of the tyre 100 and substantially perpendicular to the equatorial plane M-M of the tyre 100.

Each annular reinforcing structure 103 is associated with the carcass structure 101 by folding back (or turning) the opposite end edges of the at least one carcass layer 111 around the bead core 102 and the possible elastomeric filler 104, so as to form the so-called turns 101a of the carcass structure 101.

In an embodiment, the coupling between carcass structure 101 and annular reinforcing structure 103 can be done through a second carcass layer (not shown in FIG. 1) applied in a radially outer position with respect to the carcass layer 111.

An anti-abrasion strip 105 is arranged at each annular reinforcing structure 103 so as to wrap around the annular reinforcing structure 103 along the axially inner, axially outer and radially inner areas of the annular reinforcing structure 103, thus being interposed between the latter and the rim of the wheel when the tyre 100 is mounted on the rim. Such an anti-abrasion strip 105 may however not be provided.

The support structure 100a comprises, in a radially outer position with respect to the carcass structure 101, a crossed belt structure 106 comprising at least two belt layers 106a, 106b arranged in radial juxtaposition over one another.

The belt layers 106a, 106b respectively comprise a plurality of reinforcing cords 10a, 10b. Such reinforcing cords 10a, 10b have an orientation inclined with respect to the circumferential direction of the tyre 100, or to the equatorial plane M-M of the tyre 100, by an angle comprised between 15° and 45°, preferably between 20° and 40°. For example, such an angle is equal to 30°.

The reinforcing cords 10a, 10b of a belt layer 106a, 106b are parallel to each other and have a crossed orientation with respect to the reinforcing cords 10b, 10a of the other belt layer 106b, 106a.

In ultra-high-performance tyres, the belt structure 106 can be a turned crossed belt structure. Such a belt structure is made by arranging at least one belt layer on a support element and turning the opposite lateral end edges of said at least one belt layer. Preferably, a first belt layer is initially deposited on the support element, then the support element is radially expanded, then a second belt layer is deposited on the first belt layer and finally the opposite axial end edges of the first belt layer are turned onto the second belt layer to at least partially cover the second belt layer, which is the radially outermost one. In some cases, it is possible to arrange a third belt layer on the second belt layer. Advantageously, the turning of the axially opposite end edges of a belt layer on another belt layer radially outside of it provides the tyre with greater reactivity and responsiveness when tackling a bend.

The support structure 100a comprises, in a radially outer position with respect to the crossed belt structure 106, at least one zero degrees reinforcing layer 106c, commonly known as “zero degrees belt”. It comprises reinforcing cords 10c oriented in a substantially circumferential direction. Such reinforcing cords 10c thus form an angle of a few degrees (typically less than 10°, for example comprised between 0° and 6°) with respect to the equatorial plane M-M of the tyre 100.

The tread band 109 made of elastomeric material is applied in a radially outer position with respect to the zero degrees belt layer 106c.

Respective sidewalls 108 made of elastomeric material are also applied on the opposite lateral surfaces of the carcass structure 101, in an axially outer position with respect to the carcass structure 101 itself. Each sidewall 108 extends from one of the lateral edges of the tread band 109 up to the respective annular reinforcing structure 103.

The anti-abrasion strip 105, if present, extends at least up to the respective sidewall 108.

In some specific embodiments, like the one illustrated and described herein, the rigidity of the sidewall 108 can be improved by providing a stiffening layer 120, generally known as “flipper” or additional strip-like insert, which has the function of increasing the rigidity and integrity of the annular reinforcing structure 103 and of the sidewall 108.

The flipper 120 is wound around a respective bead core 102 and the elastomeric filler 104 so as to at least partially surround the annular reinforcing structure 103. In particular, the flipper 120 wraps around the annular reinforcing structure 103 along the axially inner, axially outer and radially inner areas of the annular reinforcing structure 103.

The flipper 120 is arranged between the turned end edge of the carcass layer 111 and the respective annular reinforcing structure 103. Usually, the flipper 120 is in contact with the carcass layer 111 and the annular reinforcing structure 103.

In some specific embodiments, like the one illustrated and described herein, the bead structure 103 can also comprise a further stiffening layer 121 that is generally known by the name “chafer”, or protective strip, and which has the function of increasing the rigidity and integrity of the annular reinforcing structure 103.

The chafer 121 is associated with a respective turned end edge of the carcass layer 111 in an axially outer position with respect to the respective annular reinforcing structure 103 and extends radially towards the sidewall 108 and the tread band 109.

The flipper 120 and the chafer 121 comprise reinforcing cords 10d (in the attached figures those of the chafer 121 are not visible) coated with an elastomeric material or incorporated in a matrix of cross-linked elastomeric material.

The tread band 109 has, in a radially outer position, a rolling surface 109a configured to make contact with the ground. Circumferential grooves (not represented in FIG. 1) are formed on the rolling surface 109a, said grooves being connected by transversal notches (not represented in FIG. 1) so as to define on the rolling surface 109a a plurality of blocks of various shapes and sizes (not represented in FIG. 1).

A sub-layer 107 can be arranged between the zero degrees belt layer 106c and the tread band 109.

In some specific embodiments, like the one illustrated and described herein, a strip 110 consisting of elastomeric material, commonly known as “mini-sidewall”, can possibly be provided in the connection area between the sidewalls 108 and the tread band 109. The mini-sidewall 110 is generally obtained through co-extrusion with the tread band 109 and allows an improved mechanical interaction between the tread band 109 and the sidewalls 108.

Preferably, an end portion of the sidewall 108 directly covers the lateral edge of the tread band 109.

In the case of tubeless tyres, a layer of elastomeric material 112, generally known as “liner”, can also be provided in a radially inner position with respect to the carcass layer 111 to provide the necessary impermeability to the inflation air of the tyre 100.

The carcass layer 111, the crossed belt layers 106a, 106b, the zero degrees belt layer 106, the flipper 120 and the chafer 121 define reinforcing layers of the tyre 100.

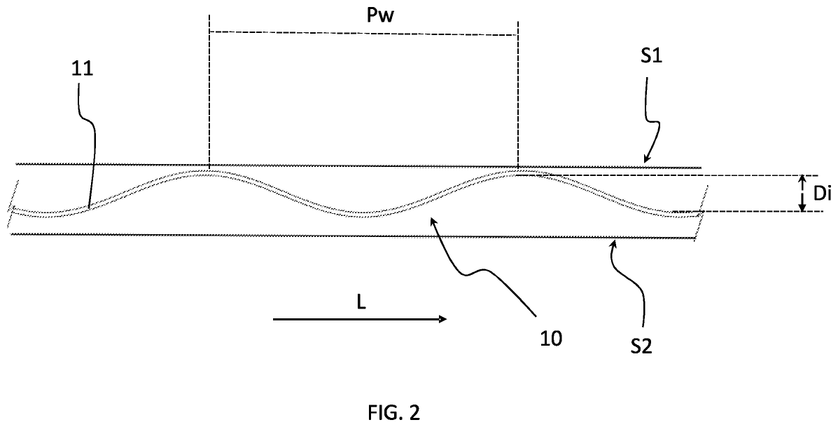

As illustrated in FIG. 2, each of such reinforcing layers comprises opposite interface surfaces S1, S2 that delimit the reinforcing layer with respect to other structural and non-structural components of the tyre 100. The reinforcing cords of each of such reinforcing layer are arranged between the respective opposite interface surfaces.

Depending on the type of tyre 100, the reinforcing cords 10a and of the belt layers 106a and 106b, the reinforcing cords 10c of the zero degrees belt layer 106c and the reinforcing cords 10d of the chafer 121 can be metallic reinforcing cords 10 made in accordance with the present invention. Such metallic reinforcing cords 10 can also be used in the carcass or belt structure of tyres for motorcycle wheels.

An example embodiment of a metallic reinforcing cord 10 in accordance with the present invention is illustrated in FIG. 2.

With reference to such a figure, the metallic reinforcing cord 10 comprises a single metallic wire 11 extending along a longitudinal direction L according to a helical geometry defined by a respective helix having a predetermined winding pitch Pw. The metallic reinforcing cord thus extends longitudinally along a helical path with the aforementioned predetermined winding pitch Pw.

Basically, the metallic cord 10 consists of the metallic wire 11.

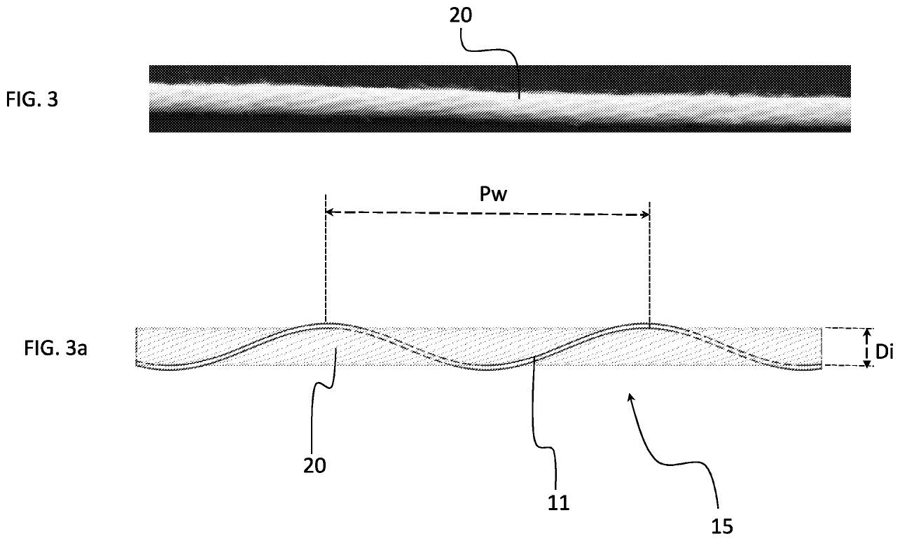

With reference to FIGS. 3 and 3a, a metallic reinforcing cord in accordance with the present invention is obtained by twisting together, in a conventional twisting machine, the metallic wire 11 and a textile yarn (for example of the type illustrated in FIG. 3) with a twisting pitch equal to the aforementioned winding pitch Pw, to form an elongated element 15 (for example of the type illustrated in FIG. 3a).

Such an elongated element 15 has a space inside the helix of the metallic wire 11 that is occupied by the textile yarn 20 (which will then be removed). Such a space increases, keeping all other parameters the same, as the diameter of the textile yarn 20 increases (and therefore as the number of filaments and/or pieces that constitute the textile yarn 20 increases) and as the twisting pitch decreases.

In each cross section of the metallic wire 11 the aforementioned space defines the inner diameter Di of the helix defined by the metallic wire 11. Such an inner diameter Di corresponds to the diameter of the textile yarn 20 in that cross section.

In the example of FIG. 2, the aforementioned inner diameter Di remains substantially constant in all of the cross sections of the helix defined by the metallic wire 11.

Such an inner diameter Di is preferably comprised between 0.7 mm and 4 mm, more preferably between 0.8 mm and 3.5 mm, even more preferably between 0.9 mm and 3 mm.

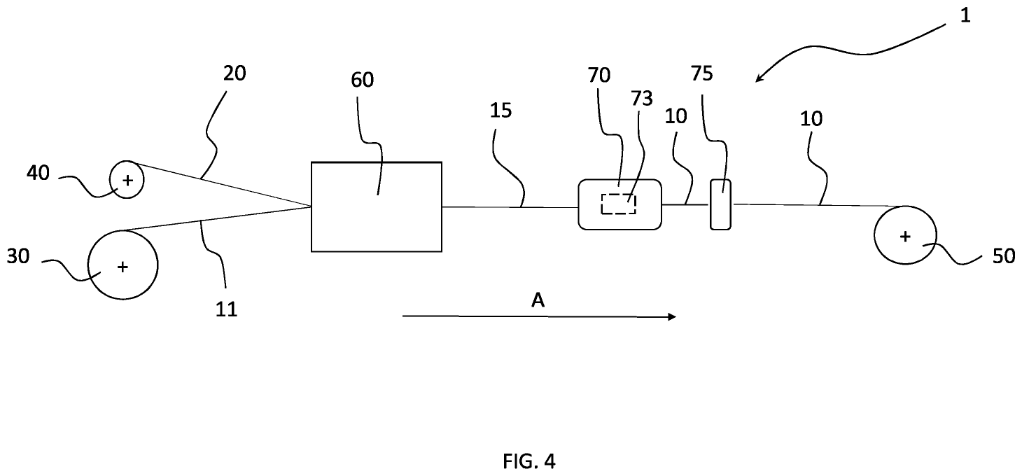

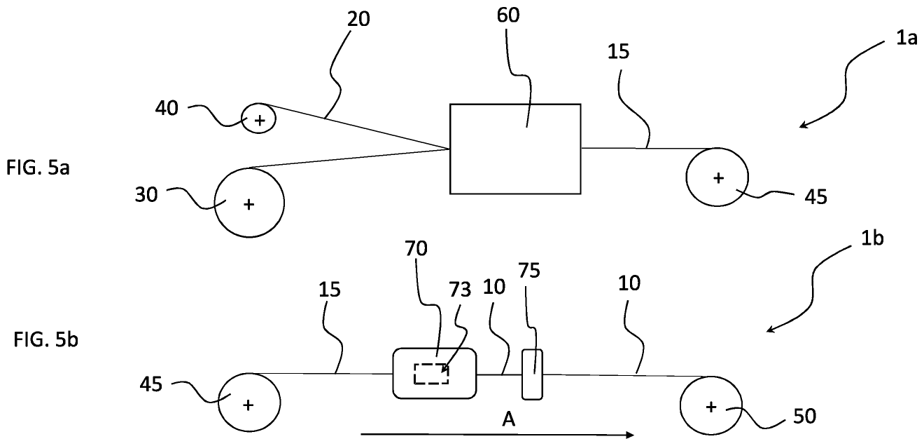

As will be described hereinafter with reference to FIGS. 4 and 5a, 5b, the textile yarn 20 is intended to be removed from the elongated element 15. After such removal, the metallic wire 11 keeps the same helical geometry that it had before the removal of the textile yarn 20.

The metallic wire 11 is preferably made of steel. The metallic wire 11 can be made of NT (Normal Tensile) steel, HT (High Tensile) steel, ST (Super Tensile) steel or UT (Ultra Tensile) steel.

The metallic wire 11 has a carbon content lower than or equal to 1, preferably lower than or equal to 0.9%.

Preferably, the carbon content is greater than or equal to 0.7%.

In preferred embodiments, the carbon content is comprised between 0.7% and 1%, preferably between 0.7% and 0.9%.

The metallic wire 11 is typically coated with brass or another corrosion-resistant coating (for example Zn/Mn).

The metallic wire 11 has a diameter preferably comprised between 0.08 mm and 0.35 m, more preferably between 0.1 mm and 0.30 mm.

The textile yarn 20 is preferably made of a water-soluble synthetic polymeric material, even more preferably a polyvinyl alcohol (PVA). Such a textile yarn 20 can be acquired from specialized producers, like for example Kuraray Co., Ltd or Sekisui Specialty Chemicals, or be made by twisting together a plurality of filaments of PVA in a conventional twisting machine.

The textile yarn 20 has a count preferably greater than, or equal to, 200 dtex, more preferably greater than, or equal to, 700 dtex.

The textile yarn 20 has a count preferably lower than, or equal to, 4400 dtex, more preferably lower than, or equal to, 1670 dtex.

In preferred embodiments, the textile yarn 20 has a count comprised between 200 dtex and 4400 dtex, preferably between 700 dtex and 1670 dtex.

The elongated element 15 can comprise more than one textile yarn 20.

The metallic wire 11 can be twisted on itself, in the same direction as, or in the opposite direction to, the direction in which it is twisted on the textile yarn 20.

The winding pitch Pw is preferably comprised between 2 mm and mm, preferably between 5 mm and 35 mm, even more preferably between 10 and 35 mm.

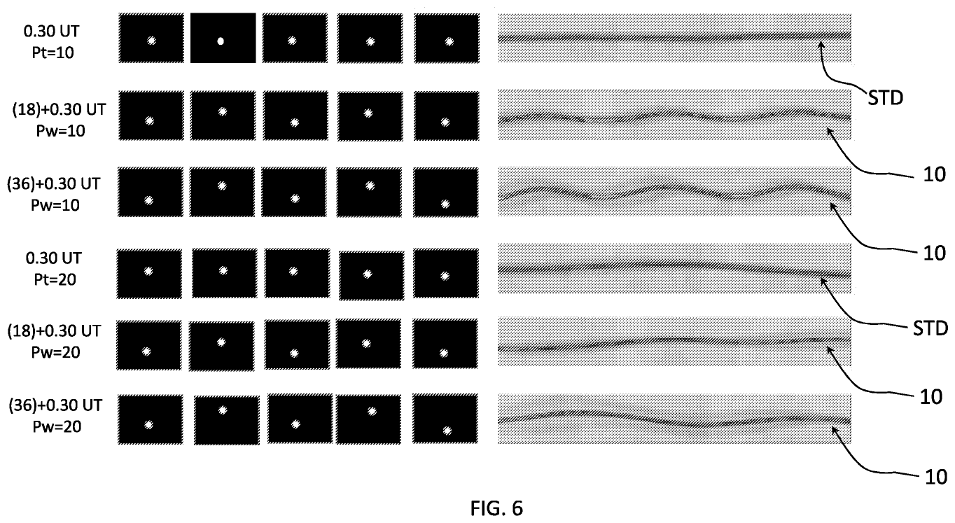

The metallic wire 11 is twisted together with the textile yarn 20 with the aforementioned winding pitch Pw to form metallic reinforcing cords 10 having different geometries, like for example those illustrated in FIG. 6.

As illustrated in FIG. 2, the metallic wire 11 of the reinforcing cord 10 is separated from at least one of the interface surfaces S1 and S2 of the respective structural component by a distance lower than or equal to the diameter of the metallic wire 11.

With reference to FIG. 4, an embodiment of an apparatus and of a process for making the metallic reinforcing cord 10 in accordance with the present invention is described.

The textile yarn 20 and the metallic wire 11 are taken from respective reels 40 and 30 and fed to a twisting device 60 to be twisted to one another, so as to form the elongated element 15. The twisting device 60 is therefore arranged downstream of the reels 40 and 30 with reference to a feeding direction indicated with A in FIG. 4.

The elongated element 15 is fed, along said feeding direction A, to a removal device 70 in which the textile yarn 20 is removed from the elongated element 15, thus making the metallic reinforcing cord 10. The removal device 70 is therefore arranged downstream of the twisting device 60 with reference to the feeding direction A.

In a preferred embodiment of the invention, the removal device 70 comprises a device 73 for feeding a hot water jet configured to hit the elongated element 15, with a hot water jet indeed, in counter-current while the elongated element 15 moves along the feeding direction A. The hot water jet dissolves the textile yarn 20 while such a jet is crossed by the metallic wire 11, which remains the only constituent element of the metallic reinforcing cord 10.

Preferably, the metallic reinforcing cord 10 thus formed then passes through a drying device 75 to be wound subsequently in a respective collection reel 50, from which it can be taken during the building of the specific structural component of the tyre 100 of interest. The drying device 75 is therefore arranged downstream of the removal device 70 with reference to the feeding direction A.

In the process described above with reference to FIG. 4, the making of the metallic reinforcing cord 10 takes place without solution of continuity with the making of the elongated element 15 (and therefore with the removal of the textile yarn 20). The metallic reinforcing cord 10 is thus made through a continuous process that, in a time sequence without interruptions or stops, comprises making the elongated element 15 by twisting together the metallic wire 11 and the textile yarn 20, moving the elongated element 15 thus made along the feeding direction A, removing the textile yarn 20, possibly drying the metallic reinforcing cord 10 thus formed and winding it in the collection reel 50.

It is however possible to make the metallic reinforcing cord 10 in two distinct operative steps, i.e. through a discontinuous process like for example the one illustrated in FIGS. 5a, 5b. Such a process differs from the one described above with reference to FIG. 4 only in that the elongated element 15, once made, is collected in a service reel 45 (FIG. 5a), from which it can be taken when desired to proceed with making the metallic reinforcing cord 10 as described earlier (FIG. 5b). The service reel 45 is thus intended to be arranged downstream of the twisting device 60 when the elongated element 15 is made and upstream of the removal device 70 when the textile yarn 20 is removed from the elongated element 15 to make the metallic reinforcing cord 10.

The metallic reinforcing cords 10 are intended to be incorporated in a piece of elastomeric material through conventional calendaring processes in conventional rubber-coating machines, thus making the various structural components of the tyre 100 described above.

The metallic reinforcing cord 10 can be made with different helical geometries depending on the particular intended application (type of tyre of interest or structural component thereof of interest). In order to change the helical geometry it is possible to intervene on one or more of the following parameters: inner diameter of the helix defined by the metallic wire 11, diameter of the metallic wire 11, diameter (or count) of the textile yarn 20 (dependent on the number of filaments and/or ends that constitute the textile yarn 20), winding pitch Pw, number of textile yarns 20.

Depending on the predetermined helical geometry the metallic reinforcing cord 10 will have different mechanical behavior that provide, in a load-elongation graph, a different curve. All of these curves will have a knee that differentiates the mechanical behavior of the metallic reinforcing cord 10 at low loads and that at high loads.

It is thus possible to make metallic reinforcing cords 10 having different rigidities, breaking loads, elongations at break and part load elongations.

In particular, it is possible to make metallic reinforcing cords 10 having part load elongations even equal to 12% and elongations at break even equal to 15%. These values are much higher than those that can be obtained with conventional single-wire metallic reinforcing cords; indeed, the latter typically have part load elongation values not greater than 1.5% and elongation at break values not greater than 4%, in the case of single-wire metallic reinforcing cords subjected to deformation through preforming.

FIG. 6 illustrates, as an example, two conventional single-wire metallic reinforcing cords, indicated with STD, and respective metallic reinforcing cords 10 made in accordance with the present invention.

To the left of each of the reinforcing cords illustrated, portions of some cross sections of the structural component that incorporates the respective reinforcing cord are shown and, to the left of such cross sections, the specific construction of the reinforcing cord is shown. Pt indicates the twisting pitch in mm of the reinforcing cords STD, whereas PW indicates the winding pitch in mm of the reinforcing cords 10. In the latter, before the symbol+the number of filaments or pieces that constitute the textile yarn 20 used to make the reinforcing cords 10 is indicated in brackets.

All the reinforcing cords illustrated in FIG. 6 comprise an UT steel wire having a diameter equal to 0.30 mm.

The first three reinforcing cords in FIG. 6 have a twisting pitch Pt equal to 10 mm, whereas the last three reinforcing cords have a winding pitch Pw equal to 20 mm. It should be noted that, keeping the other parameters the same, as the twisting/winding pitch Pt/Pw and the inner diameter of the helix increase, the geometry of the reinforcing cord and the position thereof in the structural component of the tyre change.

In particular, the two reinforcing cords indicated with STD have a slightly wavy geometry (such cords are substantially rectilinear), such geometry being obtained by feeding the metallic wire to a twisting device in which a predetermined twisting pitch Pt is preset, whereas the reinforcing cords 10 have a helical geometry, obtained through the process described above in which use is made, in the step of making the reinforcing cord, of the textile yarn 20.

Keeping the winding pitch Pw and diameter of the metallic wire the same, the two reinforcing cords 10 differ from one another only due to the different inner diameter of the helix defined by the respective metallic wire (equal to the diameter of the textile yarn 20 used to make the reinforcing cords 10). In particular, keeping the winding pitch Pw and diameter of the metallic wire the same, in one case such an inner diameter is equal to 0.9 mm and is obtained using, in the step of making the reinforcing cord 10, a textile yarn 20 having 18 filaments, whereas in the other case the inner diameter is equal to 1.2 mm and is obtained using, in the step of making the reinforcing cord 10, a textile yarn having 36 filaments.

It can be noted that the reinforcing cords 10 are more distributed over the entire volume of the structural component, going close to the opposite interface surfaces of the structural component. Differently, the two reinforcing cords STD are always distributed in a same central area of the structural component.

The Applicant has carried out some comparative tests on samples of the metallic reinforcing cords illustrated in FIG. 6 in order to evaluate the mechanical behavior of such cords. In particular, the breaking load (BL), the elongation at break (AT) and the part load elongation (PLE) were measured by subjecting such cords to a traction test carried out according to methods BISFA E6 and BISFA E7.

The result of such tests is given in Table 1 below.

TABLE 1

| | BL | AT | PLE |
|---|---|---|---|
| | (N) | (%) | (%) |
| 0.30 UT | 248 | 2.3 | 0.30 |
| P = 10 | | | |
| 18 + 0.30 UT | 243 | 2.8 | 0.70 |
| P = 10 | | | |
| 36 + 0.30 UT | 238 | 4.4 | 1.615 |
| P = 10 | | | |
| 0.30 UT | 250 | 2.3 | 0.32 |
| P = 20 | | | |
| 18 + 0.30 UT | 246 | 2.4 | 0.459 |
| P = 20 | | | |
| 36 + 0.30 UT | 247 | 2.8 | 0.752 |
| P = 20 | | | |

It can be noted that, keeping the twisting/winding pitch Pt/Tw and the diameter of the metallic wire the same, the reinforcing cords 10 in accordance with the present invention have a part load elongation much greater than that of conventional metallic reinforcing cords, substantially for the same breaking load. It can also be noted that there is an increase in the elongation at break.

Such tests confirm the opinion of the Applicant that the metallic reinforcing cords made in accordance with the present invention make it possible to achieve part load elongations and elongations at break higher than those of conventional single-wire metallic reinforcing cords. This is due to the different geometry of the metallic reinforcing cords of the invention with respect to that of conventional single-wire metallic reinforcing cords. The helical geometry also allows the metallic reinforcing cords of the invention to adhere better to the surrounding elastomeric material, substantially reducing the risk for the cords to protrude out of the structural component that incorporates them, even if such cords are arranged closer to the interface surfaces of the structural component.

The present invention has been described with reference to some preferred embodiments. Different modifications can be brought to the embodiments described above, still remaining within the scope of protection of the invention, defined by the following claims.

1-10. (canceled)

11. A metallic reinforcing cord for tyres for vehicle wheels, comprising:
a single metallic wire extending along a substantially helical path to form a helix having a predetermined winding pitch (Pw) and, in at least some cross sections of the helix, an inner diameter (Di) greater than, or equal to, 0.7 mm.

12. The metallic reinforcing cord according to claim 11, wherein the inner diameter (Di) is less than, or equal to, 4 mm.

13. The metallic reinforcing cord according to claim 12, wherein the inner diameter (Di) ranges from 1.5 mm to 3 mm.

14. The metallic reinforcing cord according to claim 11, wherein the metallic reinforcing cord consists of the single metallic wire.

15. The metallic reinforcing cord according to claim 11, wherein the metallic wire has a diameter less than, or equal to, 0.35 mm.

16. The metallic reinforcing cord according to claim 11, wherein the metallic wire has a diameter greater than, or equal to, 0.08 mm.

17. The metallic reinforcing cord according to claim 11, wherein the winding pitch (Pw) is greater than, or equal to, 2 mm.

18. The metallic reinforcing cord according to claim 11, wherein the winding pitch (Pw) is less than, or equal to, 35 mm.

19. A tyre for vehicle wheels, comprising:
at least one reinforcing layer delimited by two opposite interface surfaces (S1, S2) and a plurality of metallic reinforcing cords arranged between the two opposite interface surfaces (S1, S2), wherein at least some of the metallic reinforcing cords are metallic reinforcing cords according to claim 11.

20. The tyre according to claim 19, wherein in at least some cross sections of the at least one reinforcing layer the metallic wire is spaced apart from one of the opposite interface surfaces (S1, S2) by a distance less than or equal to the diameter of the metallic wire.
